(19) United States
(12) Patent Application Publication
(10) Pub. No.: US 2019/0227420 A1
(43) Pub. Date: Jul. 25, 2019

(54) IMAGE PROJECTION APPARATUS

(71) Applicant: CANON KABUSHIKI KAISHA, Tokyo (JP)

(72) Inventor: Kazuyuki Kuratomi, Sakura-shi (JP)

(21) Appl. No.: 16/253,574

(22) Filed: Jan. 22, 2019

(30) Foreign Application Priority Data
Jan. 25, 2018 (JP) 2018-010266

(51) Int. Cl. G03B 21/20; H05B 41/39

(52) U.S. Cl. CPC G03B 21/2053; G03B 21/006; H05B 41/39; G03B 21/2033

(57) ABSTRACT

An image projection apparatus is configured to project an image using light from a light source and includes a controller configured to control a power supplied to the light source, and a light source state acquirer configured to acquire light source state information representing a state of the light source. The controller controls the power based on the light source state information acquired before or after the power is reduced so that a light amount of the light source does not fall below a predetermined light amount, in reducing the power so as to darken the image according to information on a brightness of the image.

### BACKGROUND OF THE INVENTION

### Field of the Invention

The present invention relates to an image projection apparatus (referred to as a “projector” hereinafter) configured to project an image using light from a light source.

### Description of the Related Art

Some projectors use solid state light sources, such as an LED and a laser diode (LD). Japanese Patent Laid-open No. (“JP”) 2014-106420 discloses a projector that combines a light amount adjustment by (PMW-) controlling a time ratio of turning on and off of the LD and a light amount adjustment by controlling the driving current of the LD, and can accurately adjust a wide range of the brightness of a projected image.

The brightness of the projected image can be lowered in order to adjust the contrast in the projected image or to prolong the life of the light source. A certain degree of brightness is necessary in order to secure the visibility of the projected image. A lower limit settable by the user may be provided in adjusting the brightness of the projected image. A driving condition of the light source is set based on the setting of the brightness adjustment, but the light amount of the light source decreases even under the same driving condition due to its deterioration. Thus, when the user sets the brightness of the projected image to the lower limit and the light amount decreases due to the deterioration of the light source, the brightness for securing the visibility cannot be obtained.

### SUMMARY OF THE INVENTION

The present invention provides an image projection apparatus capable of securing the visibility of a projected image irrespective of deterioration of a light source.

An image projection apparatus according to one aspect of the present invention is configured to project an image using light from a light source and includes a controller configured to control a power supplied to the light source, and a light source state acquirer configured to acquire light source state information representing a state of the light source. In reducing the power so as to darken the image according to the information on a brightness of the image, the controller controls the power based on the light source state information acquired before or after the power is reduced so that a light amount of the light source does not fall below a predetermined light amount.

A control method according to another aspect of the present invention configured to control a power supplied to a light source for an image projection apparatus configured to project an image using light from the light source, the control method comprising the steps of acquiring light source state information representing a state of the light source, and controlling the power based on the light source state information acquired before or after the power is reduced so that a light amount of the light source does not fall below a predetermined light amount, in reducing the power so as to darken the image according to information on a brightness of the image.

A non-transitory computer-readable storage medium for storing a computer program that causes a computer in an image projection apparatus that projects an image using light from a light source to execute the above control method also constitutes another aspect of the present invention.

Further features of the present invention will become apparent from the following description of exemplary embodiments with reference to the attached drawings.

### BRIEF DESCRIPTION OF THE DRAWINGS

FIG. 1 is a block diagram illustrating a configuration of a projector according to a first embodiment.

FIG. 2 is a flowchart illustrating light source control processing according to the first embodiment.

FIG. 3 illustrates a change of a light-source light source for integrated turning-on time according to the first embodiment (and second embodiment).

FIG. 4 illustrates in a driving current change of a light source for the integrated turning-on time according to the first embodiment (and second embodiment).

FIG. 5 is a flowchart illustrating light source control processing according to the second embodiment.

FIG. 6 is a flowchart illustrating light source control processing according to a third embodiment.

### DESCRIPTION OF THE EMBODIMENTS

Referring now to the accompanying drawings, a description will be given of embodiments of the present invention.

### First Embodiment

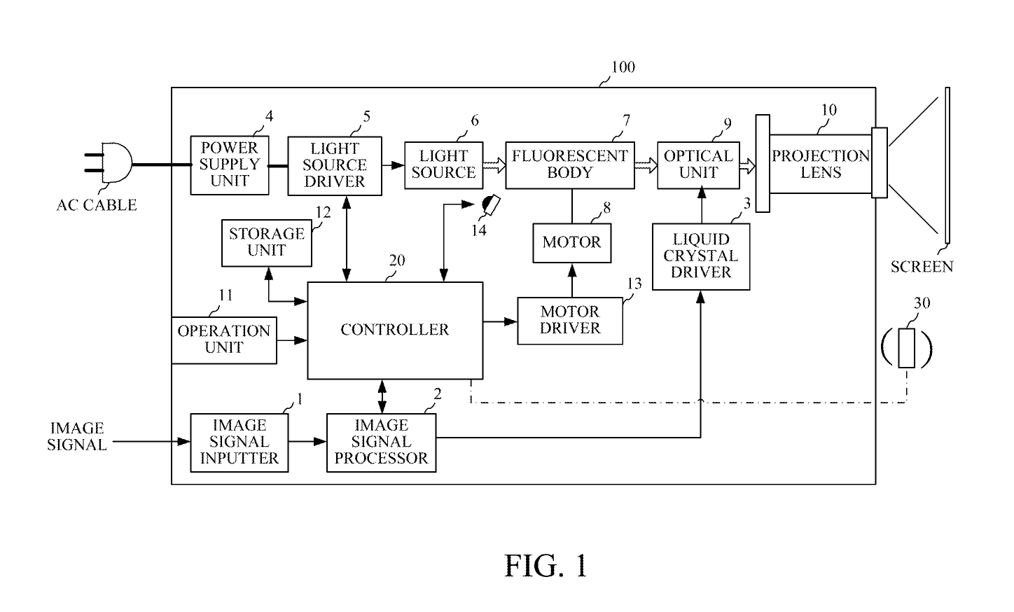

FIG. 1 illustrates a configuration of a projector 100 as an image projection apparatus according to a first embodiment of the present invention. An image signal output from an external device, such as a personal computer, is input to an image signal inputter 1. The image signal inputter 1 includes an AD converter configured to convert an analog signal, such as VGA and Video signals, into a digital signal and a receiver configured to convert a digital signal, such as HDMI (registered trademark) and DVI, into a predetermined digital signal format. The digital image signal converted by the image signal inputter 1 is sent to an image signal processor 2.

The image signal processor 2 includes a DSP or the like dedicated for image signal processing and performs scaling processing for reading a resolution of the input digital image signal and for converting it into an image signal having a resolution necessary for internal processing, menu display processing, and keystone correction processing and the like in a button operation. The digital image signal processed by the image signal processor 2 is sent to a liquid crystal driver 3, which converts it into a liquid crystal driving signal configured to drive a liquid crystal panel (which will be described later) in an optical unit 9.

A power supply unit 4 converts an AC power supply input from the outside into a DC power supply, and supplies the power to a light source driver 5 and each component in the projector 100. The light source driver 5 is a driving circuit configured to turn on (emit) a light source 6, and includes a power source circuit, such as a DC/DC converter. The light source driver 5 turns on and off the light source 6 and increases or decreases the driving power supplied to the light source 6 according to the light source control signal from a controller 20.

The light source 6 includes one or more LDs. The light emitted from the light source 6 is applied as excitation light to a fluorescent body 7. The fluorescent body 7 converts part of the excitation light into fluorescent light. The fluorescent body 7 is made by annularly applying a fluorescent material to a wheel, and is rotated by a motor 8. A motor driver 13 controls a rotation, a stop, and a rotation speed of the motor 8.

White illumination light as mixed light of excitation light (nonconverted light) and fluorescent light emitted from the fluorescent body 7 enters the optical unit 9. The optical unit 9 includes an illumination optical system configured to make uniform the illumination light, a color separating optical system configured to separate the illumination light into three or RGB color light fluxes, three liquid crystal panels configured to image-modulate the three color light fluxes respectively, and a color combining optical system configured to combine three color light fluxes. The liquid crystal panel may be a transmission type or a reflection type. One or three digital micromirror devices may be used in place of the three liquid crystal panels. The image light combined by the color combining optical system is enlarged and projected onto a projection surface, such as a screen, by a projection lens 10. Thereby, a full color projection image is displayed.

The controller 20 includes a microcomputer (CPU) and controls the entire projector 100. For example, the light source 6 is turned on and off, or the driving power supplied to the light source 6 is controlled to increase or decrease the light amount of the light source 6 by outputting a light source control signal to the light source driver 5.

An operation unit 11 includes buttons configured to turn on and off the power supply to the projector 100, a light receiving sensor configured to receive operation light from a remote controller, and the like. Upon detecting the operation of the operation unit 11 (including the reception of the operation light from the remote controller), the controller 20 performs a control corresponding to the operation.

A light amount sensor (light source state acquirer) 14 detects a light amount of the light source 6 which is one of the states of the light source 6. The light amount sensor 14 may detect the light amount itself emitted from the light source 6 or may detect the light amount at any position from the light source 6 to the projection lens 10. It may also detect a light amount projected on the projection surface.

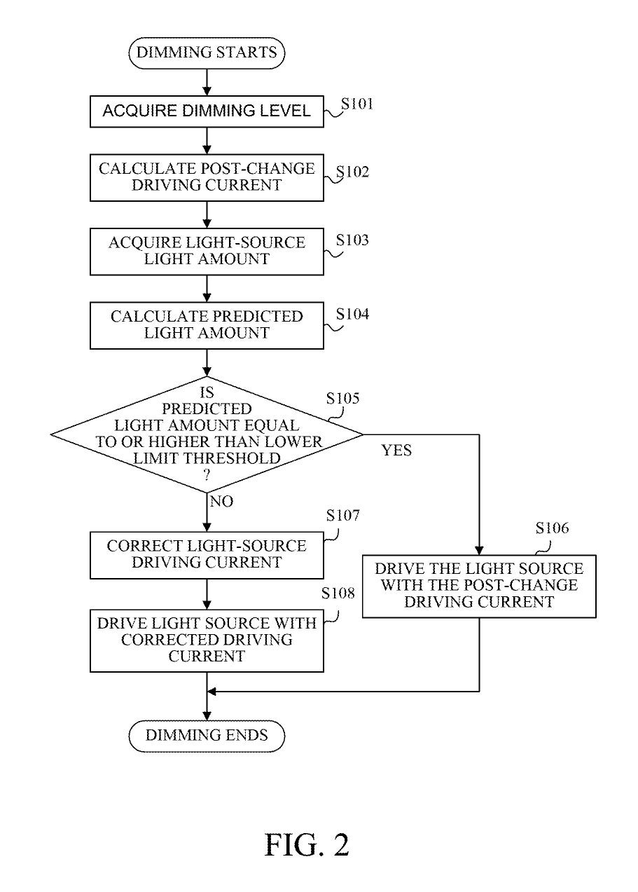

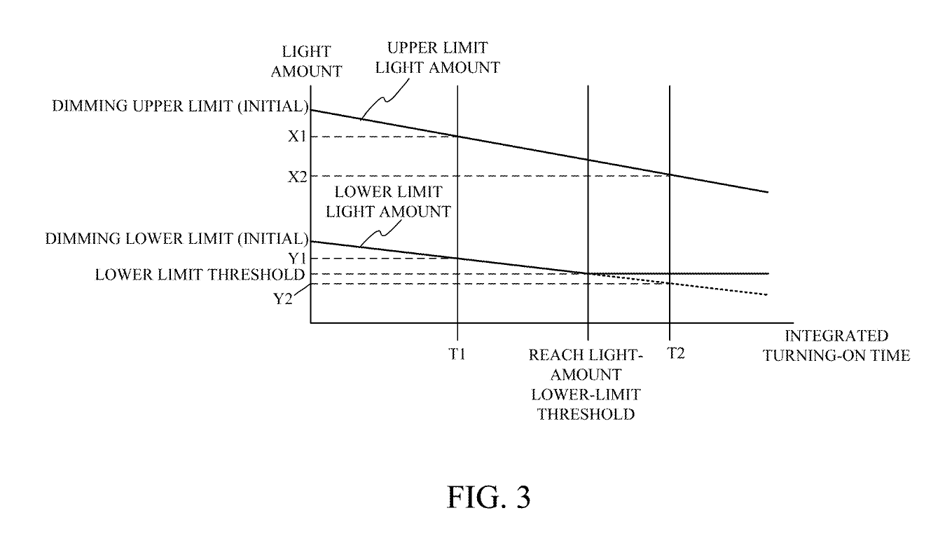

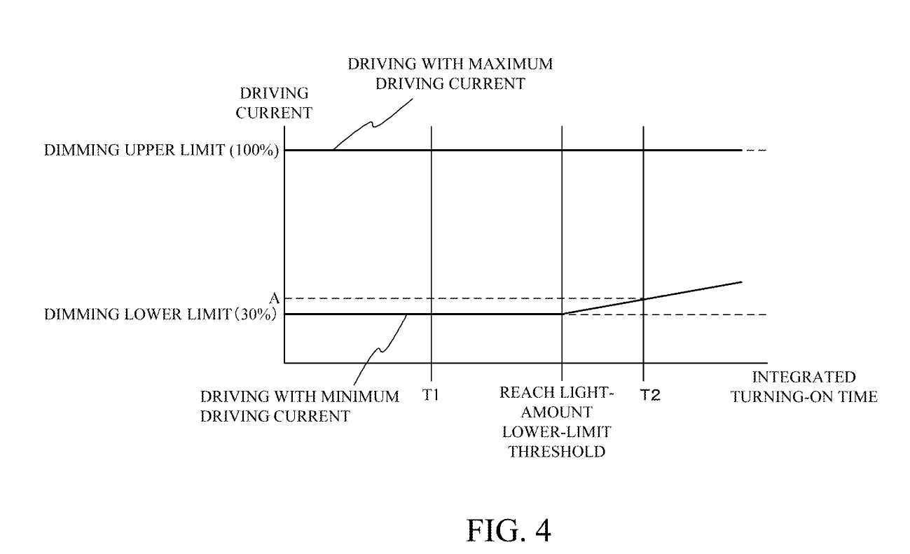

Referring now to a flowchart of FIG. 2 and FIGS. 3 and 4, a description will be given of light source control processing performed by the projector 100 (controller 20) according to this embodiment. FIG. 3 illustrates a change of a light source (referred to as a “light-source light amount” hereinafter) emitted from the light source 6 for the integrated turning-on time of the light source 6 or the deterioration of the light source 6. FIG. 4 illustrates a change in the driving power (herein the driving current) supplied to the light source 6 for the integrated turning-on time. The controller 20 executes this processing according to a computer program stored in a storage unit 12.

The user can change the brightness of the projected image by projecting and displaying a menu (referred to as OSD hereinafter) on a projection surface by the operation of an operation unit 11 in changing the brightness of the image, and by changing a numerical value or gauge indicating the brightness in the OSD. The operation unit 11 and OSD constitute a brightness setter. Changing (adjusting) the brightness of the projected image will be referred to as dimming hereinafter. This embodiment discusses a case where the user dims the projected image in a variable range from a bright side (herein the brightest dimming upper limit level) to the darkest dimming lower limit level.

When the dimming starts, the controller 20 acquires a dimming level corresponding to the brightness setting (user setting or information on the brightness of the image) on the OSD by the user in the step S101. As described above, assume that the user sets the dimming lower limit level in the variable range of the dimming level in this embodiment.

Next, in the step S102, the controller 20 calculates the driving current supplied to the light source 6 from the dimming level acquired in the step S101. In FIG. 4, the driving current of 100% is set to the dimming upper limit level at which the projected image becomes the brightest, and the driving current of 30% is set to the dimming lower limit level at which the projected image becomes the darkest. Since the user sets the dimming lower limit level in the step S101, the controller 20 calculates the driving current of 30% as a target current (target power) to be decreased. The controller 20 provisionally sets the driving current of 30% at this time, and does not control the light source driver 5 to reduce the driving current to 30%.

Next, in the step S103, the controller 20 acquires information of the light-source light amount (light source state information) through the light amount sensor 14. When the dimming upper limit level is set in the initial state in which the light source 6 is not deteriorated, the light-source light amount is the largest, and the light-source light amount decreases as the integrated turning-on time increases (or the deterioration progresses). Even when the same driving current of 100% is supplied to the light source 6, the light-source light amount decreases due to the deterioration and thus this step confirms the current light-source light amount.

Next, in the step S104, the controller 20 calculates a predicted light amount as a post-change light amount, based on the light-source light amount in the current driving current (the driving current of 100% herein) acquired in the step S103 and a post-change driving current calculated in the step S102.

In FIG. 3, when the integrated turning-on time of the light source 6 is T1, the light-source light amount acquired from the light amount sensor 14 with the pre-change driving current of 100% is X1. When the driving current is changed from 100% to 30% from this state, the post-change predicted light amount Y1 is calculated according to the light-source light amount X1 and the change amount of the driving current. The calculated light amount is the predicted light amount for the driving current of 30% at T1. At T2 for the longer integrated turning-on time, the light amount with the driving current of 100% is X2, and the predicted light amount Y2 with the driving current of 30% calculated from it is calculated.

Next, in the step S105, the controller 20 determines whether the predicted light amount calculated in the step S104 is equal to or higher than a predetermined lower limit threshold (predetermined light amount). When the predicted light amount is less than the lower limit threshold due to the deterioration of the light source 6 and the driving current is changed, the projected image becomes darker than the expectation of by the user and the determination in this step is made before the driving current is changed. The lower limit threshold is set based on the minimum brightness at which the visibility of the projected image can be secured under the specific projection condition, the lowest brightness on the product specification, and the like.

The predicted light amount Y1 calculated at the integrated turning-on time T1 is equal to or higher than the lower limit threshold. In the step S106, the controller 20 causes the light source driver 5 to change the driving current to the driving current of 30% calculated in the step S102. Thereafter, this processing is terminated.

The predicted light amount Y2 calculated at the integrated turning-on time T 2 is lower than the lower limit threshold. In the step S107, the controller 20 corrects the driving current 30% to a higher driving current A, as illustrated in FIG. 4 so that the light-source light amount is equal to or higher than the lower limit threshold. In the step S108, the controller 20 causes the light source driver 5 to supply the driving current A to the light source 6. Thereafter, this processing is terminated.

According to this embodiment, even when the user selects the dimming lower limit level in a state where the light source deteriorates, the light source 6 can emit the light amount necessary to secure the visibility of the projected image.

### Second Embodiment

Next follows a description of a second embodiment according to the present invention. The first embodiment calculates the predicted light amount after the driving current is changed in dimming, and determines whether or not the predicted light amount is equal to or higher than the lower limit threshold. The predicted light amount is merely a predicted value, and the post-change light-source light amount may be less than the lower limit threshold depending on the setting accuracy of the driving current of the light source driver 5 or the like. Thus, this embodiment corrects the driving current by actually measuring the light-source light amount after the driving current is changed without calculating the predicted light amount. The configuration of the projector according to this embodiment is the same as that of the projector 100 according to the first embodiment illustrated in FIG. 1, and thus the same elements will be designated by the same reference numerals as those of the first embodiment.

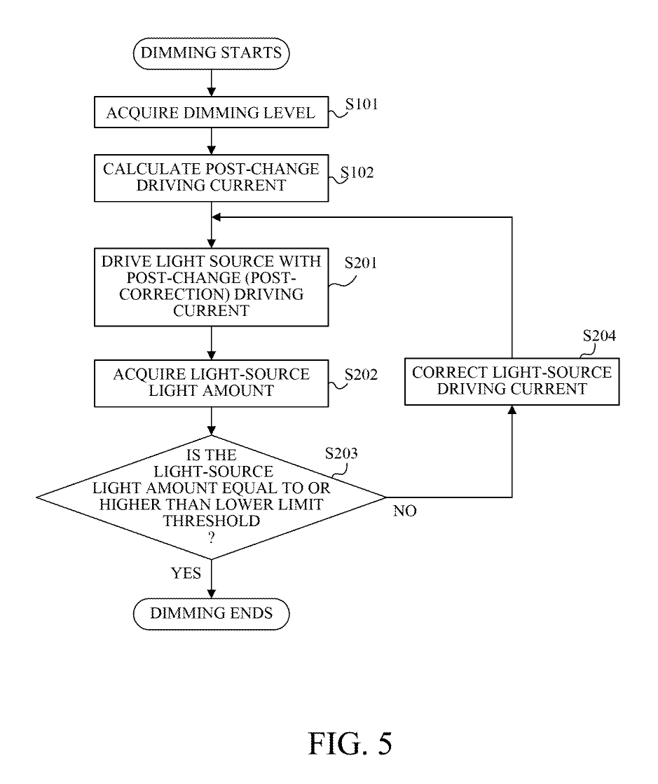

Referring now to a flowchart illustrated FIG. 5, a description will be given of the light source control processing performed by the projector 100 (controller 20) according to this embodiment. Those steps common to those of the first embodiment (FIG. 2) will be designated by the same step numbers. This embodiment also describes the case where the user performs dimming from the dimming upper limit level (with the driving current of 100%) to the dimming lower limit level (with driving current of 30%).

When the dimming starts, the controller 20 acquires the dimming level corresponding to the user setting (step S101) and calculates the post-change driving current 30% (step S102) as in the first embodiment.

Next, in the step S201, the controller 20 causes the light source driver 5 to supply the post-change driving current of 30% to the light source 6. Thereby, the light-source light amount reduces. Next, in the step S202, the controller 20 acquires the light-source light amount (light source state information) through the light amount sensor 14.

Next, in the step S203, the controller 20 determines whether or not the light-source light amount acquired in the step S202 is equal to or higher than the lower limit threshold. In FIG. 3, at the integrated turning-on time of T1 of the light source 6, the light-source light amount Y1 after the driving current is changed is obtained. Since the light-source light amount Y1 is equal to or higher than the lower limit threshold, the controller 20 ends this processing.

The light-source light amount Y2 after the driving current is changed is obtained at the integrated turning-on time of T2, but the light-source light amount Y2 is lower than the lower limit threshold. Therefore, in the step S204, the controller 20 corrects the driving current of 30% to the higher driving current A as illustrated in FIG. 4 so that the light-source light amount is equal to or higher than the lower limit threshold. In the step S201, the controller 20 causes the light source driver 5 to supply the driving current A to the light source 6.

Thereafter, the controller 20 again obtains the light-source light amount through the light amount sensor 14 in the step S202. Next, when determining in the step S203 that the light-source light amount is equal to or higher than the lower limit threshold, the controller 20 terminates this processing, and when determining that it is still less than the lower limit threshold, the controller 20 further corrects the driving current A to a higher current in the step S204. This embodiment previously determines each change amount (correction amount) of the driving current, and again corrects the driving current if the light-source light amount higher than the lower limit threshold cannot be obtained by each correction of the driving current. The processing of the steps S201 to S204 is repeated until the light-source light amount reaches the lower limit threshold.

According to this embodiment, even when the user selects the dimming lower limit level in a state where the light source deteriorates, the light source 6 can emit the light amount necessary to secure the visibility of the projected image.

### Third Embodiment

Next follows a description of a third embodiment according to the present invention. The first and second embodiments discuss the control for causing the light source 6 to emit the light so that the light amount is not less than the lower limit threshold when the user performs dimming through the operation. Even when the user does not operate and when the control for changing the light amount is made, a similar control is necessary. For example, there is a dynamic contrast control that improves the contrast by changing the light amount of the light source according to the image to be projected (the input image signal). Where the light amount is reduced in accordance with the image, it is conceivable that the light amount is less than the lower limit threshold. Hence, this embodiment describes the control for preventing the light amount from falling below the lower limit threshold in the dynamic contrast control.

The configuration of the projector according to this embodiment is the same as that of the projector 100 according to the first embodiment illustrated in FIG. 1, and the same elements are designated by the same reference numerals as those of the first embodiment.

The image signal processor 2 analyzes (acquires) the digital image signal sent from the image signal inputter 1. More specifically, in the analysis of the digital image signal, the APL value (Average Picture Level, information on the brightness of the image) is acquired for each frame of the digital image signal. The APL value is the average value of the signal level (luminance of the image) (or average gradation level or average luminance level). When the digital image signal is bright (has a high gradation), the signal level becomes high or has a large value, and when the digital image signal is dark (has a low gradation), the signal level becomes low or has a small value.

For example, when the input digital image signal is a bright image such as that in the daytime, the APL value increases, and when the image is dark such as a night scene, the APL value decreases. Using this APL value, this embodiment calculates the dimming level (light amount), for example, by increasing the light amount from the reference light amount in order to brighten the image to be projected when the APL value is high, and by decreasing the light amount from the reference light amount so as to darken the projected image when the APL value is low. The dimming level is calculated on the assumption that 100% is set in projecting the image at the brightest level (dimming upper limit level) and 30% is set in projecting the image at the darkest level (dimming lower limit level). The controller 10 is notified of the calculated dimming level, and the digital image signal is sent to the liquid crystal driver 3.

This embodiment detects the APL value of the input digital image signal, but may detect a histogram (gradation histogram) illustrating the distribution of the digital image signal level and a WP (White Peak) value. The dimming level may be normalized by the dimming upper limit level and the dimming lower limit level, and the dimming upper limit level may be set to 1.0 and the dimming lower limit level may be set to 0.0.

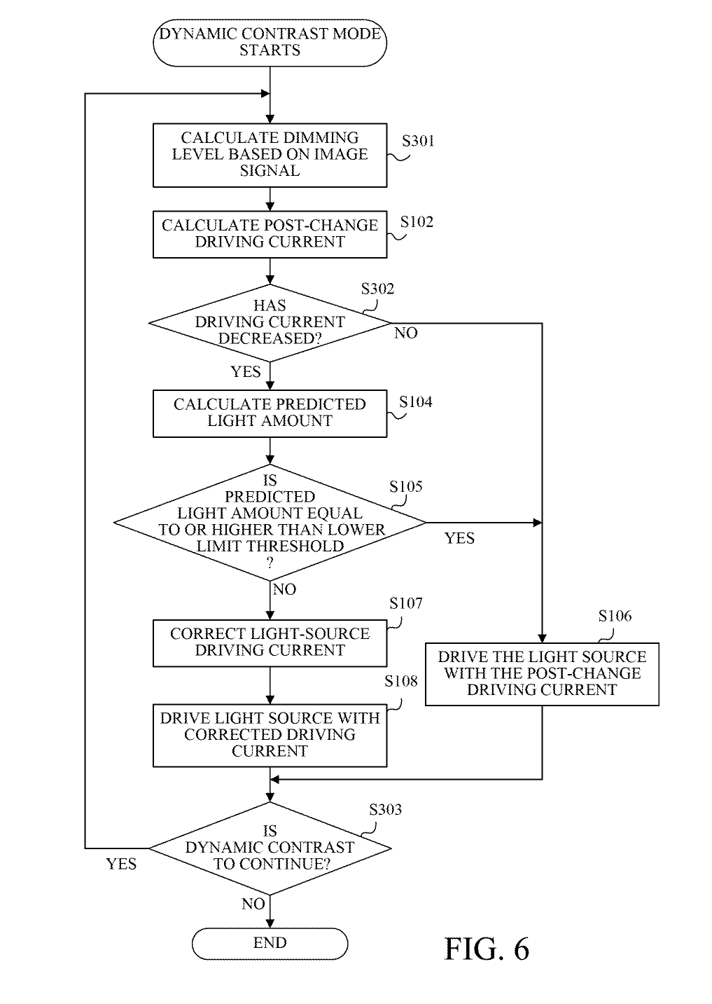

Referring now to a flowchart of FIG. 6, a description will be given of the light source control processing performed by the projector 100 (the controller 20, the image signal processor 2) according to this embodiment. The steps common to those of the first embodiment (FIG. 2) will be designated by the same step numbers. The controller 20 executes this processing according to the computer program.

When the dynamic contrast mode starts, the image signal processor 2 analyzes the input digital image signal and calculates the dimming level in the step 301. The image signal processor 2 notifies the controller 20 of the dimming level.

In the step S102, the controller 20 calculates the driving current supplied to the light source 6 from the dimming level acquired in the step S301. In FIG. 4, when the dimming level acquired in the step S301 is the dimming upper limit level, the driving current of 100% is set, and when it is the dimming lower limit level, the driving current of 30% is set.

In the step S302, the controller 20 determines whether or not the driving current calculated in the step S102 is lower than the current driving current. If the driving current does not reduce, the flow proceeds to the step S106 and the light source is driven with the driving current calculated in the step S102. If the driving current reduces, the flow proceeds to the step S104.

In the step S302, the controller 20 confirms whether the dynamic contrast control is to continue. If it is to continue, the flow returns to the step S301. If it is not to continue, the light source is driven at the dimming level before the dynamic contrast mode starts and this processing is terminated.

According to the present embodiment, where the light source deteriorates even with the dynamic contrast control, the light source 6 can emit the light amount necessary to secure the visibility of the projected image.

The first and second embodiments discuss the fixed lower limit threshold, but may change the lower limit threshold according to the projection mode of the projector 100. For example, in the projection mode that gives preference to the contrast, the lower limit threshold is made lower than that in other projection modes. In addition, in the specific projection mode among the plurality of settable projection modes, the above light source control processing may not be performed and the light-source light amount smaller than the lower limit threshold may be set.

The external light sensor 30 as an ambient light detector illustrated in parentheses in FIG. 1 may detect the external brightness of the projector 100, such as the brightness of the projection surface and the brightness of the environment in which the projector 100 is installed (indoor etc.), and the lower limit threshold may be changed according to the detected external brightness. When the detected external brightness falls within a predetermined range, the light-source light amount may be set smaller than the lower limit threshold without performing the above light-source control processing.

A voltmeter or a temperature sensor may be provided as a light source state acquirer instead of the light amount sensor 14 used in the first and second embodiments and the voltage applied to the light source 6 or the temperature of the light source 6 may be detected. When the light source 6 further deteriorates, the voltage necessary to drive the light source 6 can rise or the resultant temperature of the light source 6 can rise. Therefore, the deterioration of the light source 6 can be detected through the voltage or temperature.

The variable light intensity range of the light source may be displayed on the OSD as the display unit. In this case, in controlling the drive current so that the light-source light amount is not less than the lower limit light amount by the light source control processing, the light amount variable range to be displayed may be changed.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2018-010266, filed on Jan. 25, 2018, which is hereby incorporated by reference herein in its entirety.

What is claimed is:

1. An image projection apparatus configured to project an image using light from a light source, the image projection apparatus comprising:
a controller configured to control a power supplied to the light source; and
a light source state acquirer configured to acquire light source state information representing a state of the light source;
wherein the controller controls the power based on the light source state information acquired before or after the power is reduced so that a light amount of the light source does not fall below a predetermined light amount, in reducing the power so as to darken the image according to information on a brightness of the image.

2. The image projection apparatus according to claim 1, wherein the controller calculates a target power to which the power is to be reduced, in accordance with the information on the brightness of the image, calculates a predicted light amount of the light source corresponding to the target power using the target power and the light source state information, and controls the power so as to supply the power higher than the target power to the light source when the predicted light amount is lower than the predetermined light amount.

3. The image projection apparatus according to claim 1, wherein the controller increases the power when the light amount of the light source acquired using the light source state information acquired after the power is reduced is lower than the predetermined light amount.

4. The image projection apparatus according to claim 1, wherein the controller changes the predetermined light amount in accordance with a projection mode set in the image projection apparatus.

5. The image projection apparatus according to claim 1, wherein the controller does not control the power to prevent the light amount of the light source from being lower than the predetermined light amount in a specific projection mode among a plurality of projection modes settable in the image projection apparatus.

6. The image projection apparatus according to claim 1, further comprising an ambient light detector configured to detect an external brightness of the image projection apparatus,
wherein the controller changes the predetermined light amount according to the external brightness.

7. The image projection apparatus according to claim 1, further comprising an ambient light detector configured to detect an external brightness of the image projection apparatus,
wherein the controller does not control the power to prevent the light amount of the light source from being lower than the predetermined light amount when the external brightness falls within a predetermined range of brightness.

8. The image projection apparatus according to claim 1, further comprising a brightness setter configured to provide a user setting for the brightness of the image,
wherein the controller acquires the user setting as information on the brightness of the image.

9. The image projection apparatus according to claim 8, further comprising a display unit configured to display a light amount variable range of the light source according to the user setting,
wherein the controller changes the light amount variable range to be displayed in controlling the power to prevent the light amount of the light source from being lower than the predetermined light amount.

10. The image projection apparatus according to claim 1, wherein the controller acquires a luminance of the image as the information on the brightness of the image.

11. The image projection apparatus according to claim 10, wherein information representing the luminance of the image is any one of an average gradation level, a gradation histogram, and a maximum gradation value.

12. The image projection apparatus according to claim 1, wherein the light source state acquirer includes a light amount sensor configured to acquire a light amount of the light source as the light source state information.

13. A control method configured to control a power supplied to a light source for an image projection apparatus configured to project an image using light from the light source, the control method comprising the steps of:
acquiring light source state information representing a state of the light source; and
controlling the power based on the light source state information acquired before or after the power is reduced so that a light amount of the light source does not fall below a predetermined light amount, in reducing the power so as to darken the image according to information on a brightness of the image.

14. A non-transitory computer-readable storage medium for storing a computer program that causes a computer in an image projection apparatus that projects an image using light from a light source to execute a control method,
wherein the control method includes the steps of:
acquiring light source state information representing a state of the light source; and
controlling the power based on the light source state information acquired before or after the power is reduced so that a light amount of the light source does not fall below a predetermined light amount, in reducing the power so as to darken the image according to information on a brightness of the image.
